(19) United States
(12) Patent Application Publication
(10) Pub. No.: US 2016/0113262 A1
(43) Pub. Date: Apr. 28, 2016

(54) WRISTBAND FISHING LURE STORAGE DEVICE

(71) Applicant: Patrick Scott, Orlando, FL (US)

(72) Inventor: Patrick Scott, Orlando, FL (US)

(21) Appl. No.: 14/524,515

(22) Filed: Oct. 27, 2014

(51) Int. Cl. A01K 97/06

(52) U.S. Cl. CPC A01K 97/06

(57) ABSTRACT

A wristband fishing lure storage device includes an elastomeric main body having a recessed pocket section and a transparent cover that is removably secured over the pocket section. A removable lure holder is secured onto the recessed pocket via a connector, and a repellant pocket is disposed along the bottom side of the main body.

### TECHNICAL FIELD

The present invention relates generally to fishing lure holders and more particularly to a fishing lure holder which can be worn along the arm of a user to display and retrieve lures while actively fishing.

### BACKGROUND

The statements in this section merely provide background information related to the present disclosure and may not constitute prior art.

There are many known containers for carrying and storing fishing lures. In this regard, the majority of these items are box-like containers that are subdivided into small sections into which the lures can be placed. Depending on the type of fishing to be enjoyed, these containers can be relatively small, so as to be carried in the pocket of the fisherman, or can be large tackle boxes which also include other fishing paraphernalia.

Although these devices are useful for their intended purpose, their shape, size and operation do not allow fisherman to easily view and/or retrieve lures while fishing. This is particularly true when fly-fishing, where the fisherman is often standing in the water and cannot easily head back to shore, or put down their rod and reel to access their tackle box.

Accordingly, it would be beneficial to provide a fishing lure wristband which can be worn along the arm of a user, in order to provide the user with easy access to fishing lures and that does not suffer from the drawbacks of the above noted devices.

### SUMMARY OF THE INVENTION

The present invention is directed to a wristband fishing lure storage device. One embodiment of the present invention can include an elastomeric main body having a recessed pocket section and a transparent cover that is removably secured over the pocket section. The device can also include a removable lure holder that is constructed from foam-like material and having a plurality of apertures disposed thereon. The apertures can function to engage the hook portion of a fishing lure installed onto the lure holder.

Another embodiment of the present invention can include a repellant pocket section that is disposed along the bottom side of the main body. The repellant pocket having a porous outer surface.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a wristband fishing lure storage device that is useful for understanding the inventive concepts disclosed herein.

FIG. 2A is a top view of a removable lure holder of the wristband fishing lure storage device, in accordance with one embodiment of the invention.

FIG. 2B is a bottom view of a removable lure holder of the wristband fishing lure storage device, in accordance with one embodiment of the invention.

FIG. 3 is a perspective view of the wristband fishing lure storage device in operation, in accordance with one embodiment of the invention.

FIG. 4 is a bottom side view of the wristband fishing lure storage device, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

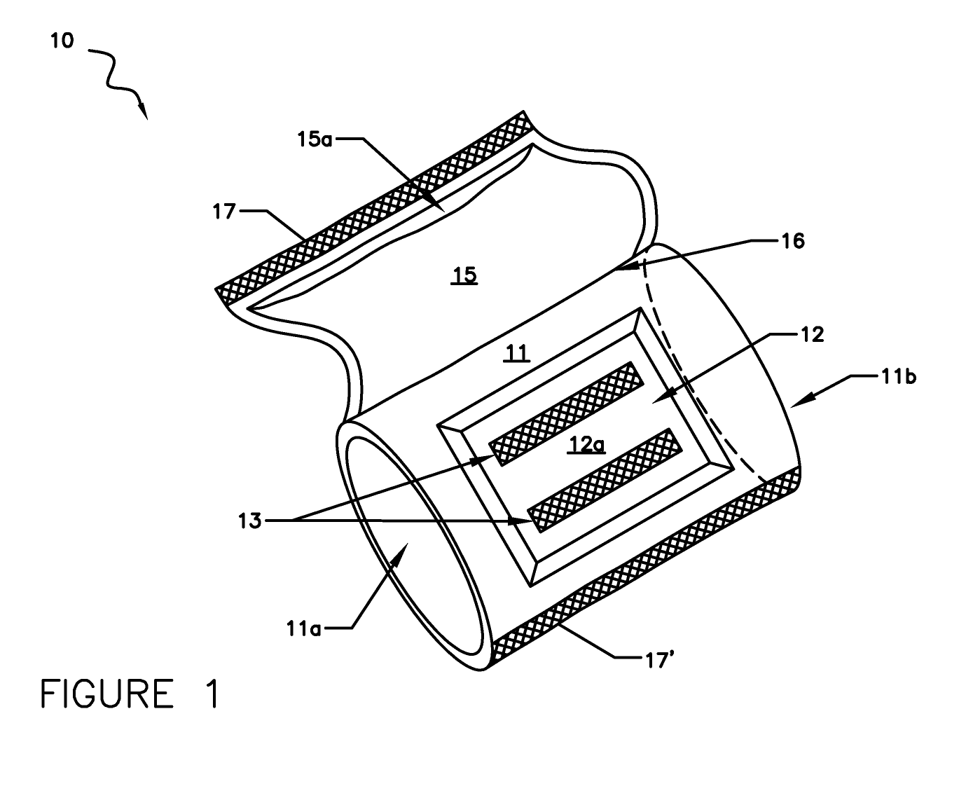

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As described herein, the terms “connector,” “complementary connector” and derivatives thereof can include any number of different elements capable of repeatedly securing two items together in a nonpermanent manner. Several nonlimiting examples include opposing strips of hook and loop material (i.e. Velcro®), magnetic elements, and/or compression fittings such as snaps and buttons. Each of these connectors can be permanently secured to the illustrated portion of the device via a permanent sealer such as glue, adhesive tape, or stitching, for example. Additionally, the terms “lure,” fishing lure” and derivatives thereof can include any number of different types of hooked bait items such as, flies, jigs, spinners, spoons, soft plastic baits, plugs, and/or spinerbaits, for example.

FIGS. 1-4 illustrate various embodiments of a wristband fishing lure storage device 10 that is useful for understanding the inventive concepts disclosed herein.

As shown in FIG. 1, one embodiment of the device 10 can include an elongated, generally tubular-shaped main body 11 having an aperture extending therethrough that is defined by a first opening 11a, a second opening 11b, a recessed pocket section 12 that is disposed along the middle section of the main body, and a cover panel 15 that functions to cover the recessed section. The device also includes one or more removable lure holders 20 which can be secured within the pocket area.

In one embodiment, the bottom wall 12a can include a first set of connectors 13 which can function to engage complementary connectors located on the removable lure holder 20 (described below). Moreover, it is preferred that the bottom wall 12a include a thin plastic plate and/or be constructed from, or coated with a puncture resistant material such as PVC coated polyester fabric, for example. Such a feature can allow the device 10 to remain lightweight and malleable, while protecting the wearers' skin from being cut by one or more of the hooks stored within the lure holder 20.

In the preferred embodiment, the main body 11 can be constructed from one or more layers of a generally elastomeric material such as nylon, polyester or other known fabric blends, which can function to stretch and contract so as to conform to the shape of the arm of a user. Of course, any number of other suitable materials are also contemplated.

The cover panel 15 can include a generally malleable member that functions to cover and protect the pocket area 12 and/or any lure holder(s) 20 that are positioned therein. In one embodiment, the top edge of the cover 15 can be permanently secured to the main body at a location above the pocket area via a seam 16. Likewise, the bottom edge of the cover 15 can be removably secured to the main body at a location below the pocket area via another set of connectors 17 and complementary connectors 17′. In this regard, the cover 15 can move about the seam 16 so as to transition between an open configuration and a closed configuration.

In the preferred embodiment, the cover 15 can be constructed from a generally transparent plastic material, in order to allow the user to view the pocket and/or lure holders 20 positioned therein. Additionally, one embodiment of the cover 15 can further include a pocket area 15a which can allow a user to store and/or display items such as a fishing license and/or fish identification chart, for example.

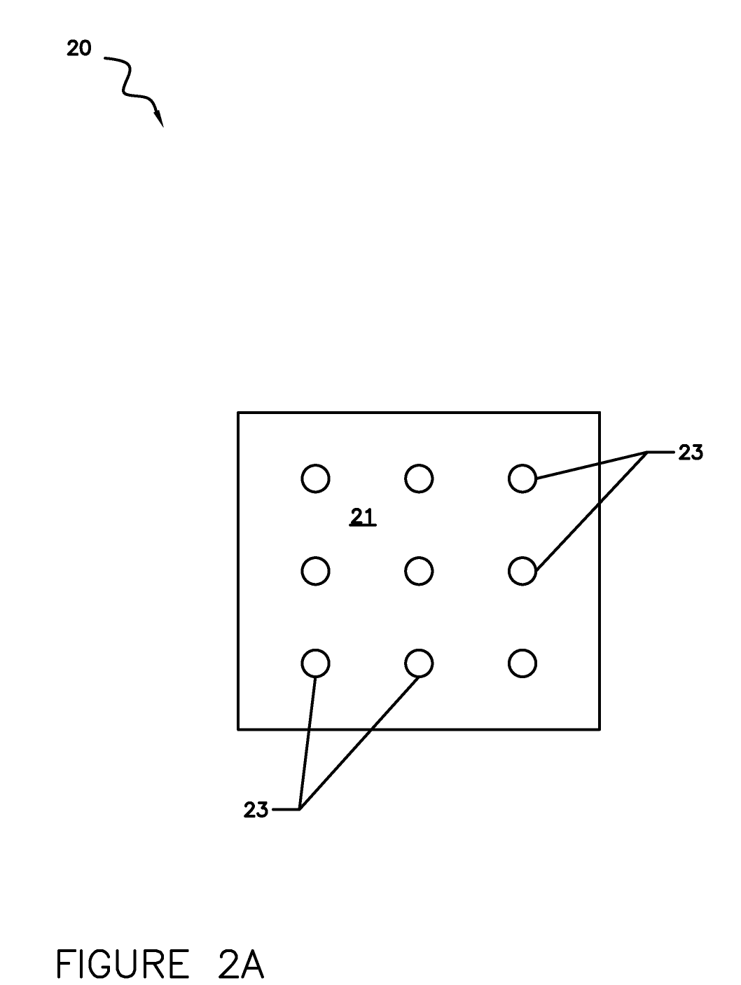

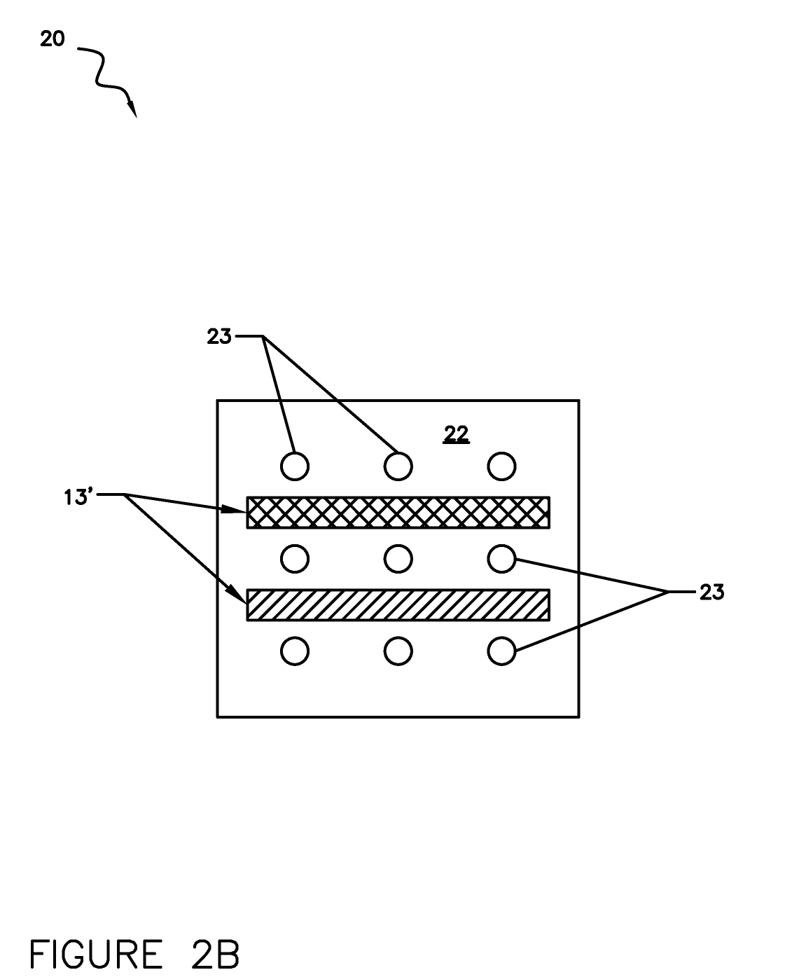

FIGS. 2A and 2B illustrate a top and bottom view of one embodiment of a removable lure holder 20 which can be inserted into the pocket area 12 of the main body. As shown, the lure holder can include a main body having a top surface 21, a bottom surface 22 and one or more complementary connectors 13′ for engaging the connectors 13 located along the bottom wall of the pocket area. The lure holder 20 can preferably include a shape that is complementary (i.e., identical or nearly identical) to the shape and size of the pocket area 12, and can be constructed from a soft, foam-like material such as neoprene, for example. Additionally, the lure holder 20 can further include a plurality of evenly spaced apertures 23 that are sized to receive the hook portion of a fishing lure. As such, when the sharp hook portion of the lure is inserted into the aperture, the soft material of the holder can maintain the lure in place, unless and until the lure is physically separated from the holder by a user. Although described above as being evenly spaced, the apertures can be arranged in any number of different fashions. Additionally, each of the apertures can include an identical shape and size, or can include any number of different shapes and sizes, so as to accommodate hooks of various shapes and dimensions.

By providing one or more removable lure holders, the device 10 advantageously allows a fisherman to pre-arrange fishing lures onto an individual holder 20 prior to leaving their home or vehicle. As such, the fisherman can prearrange any number of different holders with different types of lures based on any number of different factors such as: salt water fishing, river fishing, flats fishing, fly fishing, and the like. Such a feature, combined with the small nature of the device itself, can allow the assembled device to be stored virtually anywhere, such as a vehicle glove box, for example, without taking up large amounts of space. Moreover, when the device is in use, the apertures 23, along with the cover portion 15 function as dual layers of security to ensure the inserted lures do not accidentally separate from the holder.

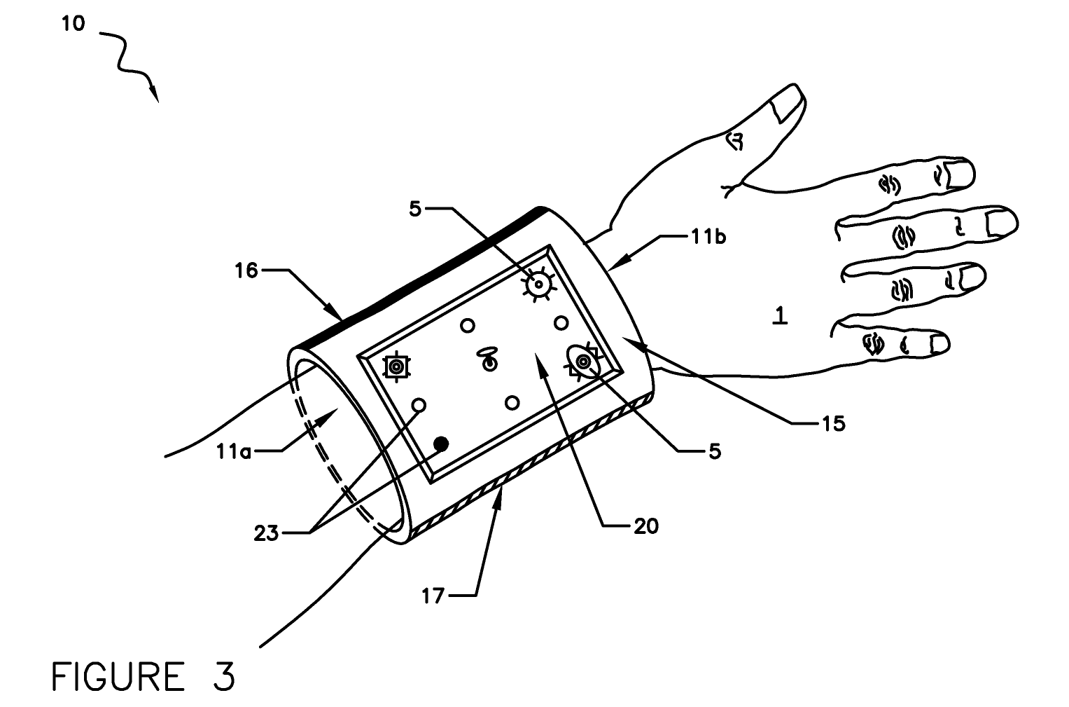

FIG. 3 illustrates one embodiment of the device 10 wherein the lure holder 20 is positioned inside the pocket area 12, and the cover 15 is in the closed orientation. As shown, when in this position, each of the lures 5 can remain visible to the user at all times, while being secured within the main body by two separate features (i.e., the apertures 23 and the cover 15). Moreover, by providing the puncture resistant layer along the main body, the portion of the user's arm 1 wearing the device is protected against getting cut by one or more of the lure hooks, in the event that he or she falls.

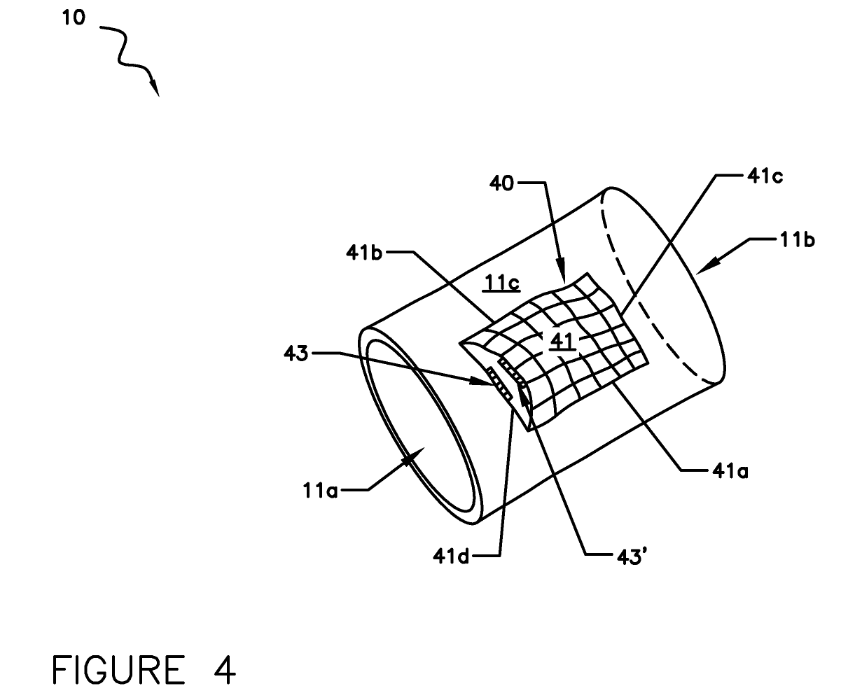

FIG. 4 illustrates one embodiment of the bottom side of the device 10 that further includes an insect repellant pocket area 40. As shown, the pocket area can include an outer surface 41 that can be permanently adhered/stitched to the bottom side of the main body 11c along the bottom edge 41a, the top edge 41b and the side edge 41c. The other side edge 41d can be removably adhered to the main body 11 via additional connectors 43 and 43′, thereby creating a hollow space for receiving a repellant. In the preferred embodiment, the outside facing surface 41 can be constructed from an extremely porous material such as mesh netting, for example, and the shape of the pocket can be suitable for receiving any number of commercially available insect repellent pads. Such a feature can function to securely hold an insect repellant while allowing the vapors from the same to surround the fisherman during device operation.

Accordingly, the above described wristband storage device 10 can function to allow a user to prearrange any number of different fishing lures to suit a desired fishing trip. While fishing, the user can see through the flap to view the lures in the holder, and can always access the same without requiring the use of both hands.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A wristband fishing lure storage device, comprising:
an elongated, generally tubular main body having a first end, a middle section, a second end and a hollow interior;
a recessed pocket section that is disposed along the middle section of the main body;
a transparent cover panel that is permanently secured along a portion of the main body, said cover panel functioning to cover the recessed pocket when in a closed orientation, and to allow access to the recessed pocket section when in an open orientation; and
a lure holder that is positionable within the recessed pocket section.

2. The wristband lure storage device of claim 1, wherein a bottom wall of the recessed pocket section is constructed from a puncture resistant material.

3. The wristband lure storage device of claim 1, further comprising:
a first connector that is secured along a bottom wall of the recessed pocket section; and
a first complementary connector that is secured along a bottom wall of the lure holder, said connectors being configured to secure the lure holder within the recessed pocket section in a removable manner.

4. The wristband lure storage device of claim 1, wherein the transparent cover includes
a top edge that is permanently secured to the main body at a location adjacent to an upper edge of the recessed pocket section, and
a bottom edge that is removably secured to the main body at a location adjacent to a lower edge of the recessed pocket section.

5. The wristband lure storage device of claim 1, wherein said lure holder further includes
a main body that is constructed from a soft, foam-like material, and having a top surface, a bottom surface and a shape that is complementary to a shape of the recessed pocket section.

6. The wristband lure storage device of claim 5, further comprising:
a plurality of apertures that are disposed along the main body of the lure holder, each of said apertures including a shape and size that is suitable for receiving and engaging a fishing hook located within an inserted fishing lure.

7. The wristband lure storage device of claim 1, wherein the main body is constructed from an elastomeric material, and is configured to stretch and contract to fit a shape of a user's arm.

8. The wristband lure storage device of claim 1, further comprising:
a transparent pocket area that is disposed along the transparent cover panel.

9. The wristband lure storage device of claim 1, further comprising:
an insect repellant pocket area that is disposed along a bottom side of the main body.

10. The wristband lure storage device of claim 10, wherein said insect repellant pocket further includes an outer surface that is constructed from a mesh netting material.
